(19) United States
(12) Patent Application Publication
(10) Pub. No.: US 2025/0212231 A1
(43) Pub. Date: Jun. 26, 2025

(54) USER EQUIPMENT FOR SIDELINK TRANSMISSION

(71) Applicant: LENOVO (BEIJING) LIMITED, Beijing (CN)

(72) Inventors: Xiaodong Yu, Beijing (CN); Yu Zhang, Beijing (CN); Haipeng Lei, Beijing (CN); Zhennian Sun, Beijing (CN); Xin Guo, Beijing (CN)

(21) Appl. No.: 18/851,970

(22) PCT Filed: Mar. 31, 2022
(86) PCT No.: PCT/CN2022/084575

§ 371 Date: Sep. 27, 2024

(51) Int. Cl. H04W 72/25; H04L 27/26; H04W 74/0808; H04W 76/18

(52) U.S. Cl. CPC H04W 72/25; H04L 27/2678; H04W 74/0808; H04W 76/18

(57) ABSTRACT

The present application relates to a UE for sidelink transmission. The UE includes a processor and a transceiver coupled to the processor. The processor is configured to: determine a candidate resource set having a first number of candidate resources, wherein the first number of candidate resources is greater than a second number of candidate resources configured by a network node; report the candidate resource set from a physical layer of the UE to a higher layer of the UE; and determine at least one resource from the candidate resource set by the higher layer of the UE for a sidelink transmission on the unlicensed band.

### TECHNICAL FIELD

Embodiments of the present application generally relate to wireless communication technology, especially to a user equipment for sidelink transmission on unlicensed spectrum under 3GPP (3rd Generation Partnership Project) 5G new radio (NR).

### BACKGROUND

With network developments of 3rd Generation Partnership Project (3GPP) 5G New Radio (NR), sidelink transmission between user equipment is developed. For improving the utilization of the radio resource, technologies of sidelink transmission on unlicensed spectrum is introduced. However, for sidelink communication mode 2 (i.e., the mode that UEs may autonomously select resources for sidelink transmission), some issues of decreasing the resource utilization efficiency need to be solved.

### SUMMARY

Some embodiments of the present application provide a user equipment (UE). The UE includes a processor and a transceiver coupled to the processor. The processor is configured to: receive, via the transceiver, a resource pool configuration information from a network node, wherein the resource pool configuration information indicates a cyclic prefix (CP) extension having a length before a sidelink transmission in a resource pool; and perform a listen-before-talk (LBT) procedure for a CP extension transmission with the length and the sidelink transmission in the resource pool on an unlicensed band.

Some embodiments of the present application provide a UE. The UE includes a processor and a transceiver coupled to the processor. The processor is configured to: determine a candidate resource set having a first number of candidate resources, wherein the first number of candidate resources is greater than a second number of candidate resources configured by a network node; report the candidate resource set from a physical layer of the UE to a higher layer of the UE; and determine at least one resource from the candidate resource set by the higher layer of the UE for a sidelink transmission on the unlicensed band.

Some embodiments of the present application provide a UE. The UE includes a processor and a transceiver coupled to the processor. The processor is configured to: report a candidate resource set from a physical layer of the UE to a higher layer of the UE; and determine a plurality of sets of resource from the candidate resource set by the higher layer of the UE for a sidelink transmission on the unlicensed band.

Some embodiments of the present application provide a UE. The UE includes a processor and a transceiver coupled to the processor. The processor is configured to: determine a candidate resource set having a first number of candidate resources; determine the first number of candidate resources is less than a second number of candidate resources configured by a network node; increase a reference symbol received power (RSRP) threshold by a specific value; and determine whether the increased RSRP threshold is greater than an energy detection threshold. When the increased RSRP threshold is less than the energy detection threshold, the UE updates the candidate resource set according to the increased RSRP threshold. When the increased RSRP threshold is equal to or greater than the energy detection threshold, the UE reports the candidate resource set to a higher layer of the UE.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates a schematic diagram of CP transmissions in accordance with some embodiments of the prior art.

FIG. 3 illustrates a schematic diagram of message transmission in accordance with some embodiments of the present application.

FIG. 4 illustrates a schematic diagram of CP transmissions in accordance with some embodiments of the present application.

FIG. 5 illustrates a schematic diagram of message transmission in accordance with some embodiments of the present application.

FIG. 6 illustrates a schematic diagram of message transmission in accordance with some embodiments of the present application.

FIG. 7 illustrates a schematic diagram of message transmission in accordance with some embodiments of the present application.

FIG. 8 illustrates a schematic diagram of message transmission in accordance with some embodiments of the present application.

FIG. 9 illustrates a schematic diagram of message transmission in accordance with some embodiments of the present application.

FIG. 10 illustrates a schematic diagram of message transmission in accordance with some embodiments of the present application.

FIG. 11 illustrates a block diagram of a user equipment in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. Embodiments of the present application may be provided in a network architecture that adopts various service scenarios, for example but is not limited to, 3GPP 3G, long-term evolution (LTE), LTE-Advanced (LTE-A), 3GPP 4G, 3GPP 5G NR (new radio), etc. It is contemplated that along with the 3GPP and related communication technology development, the terminologies recited in the present application may change, which should not affect the principle of the present application.

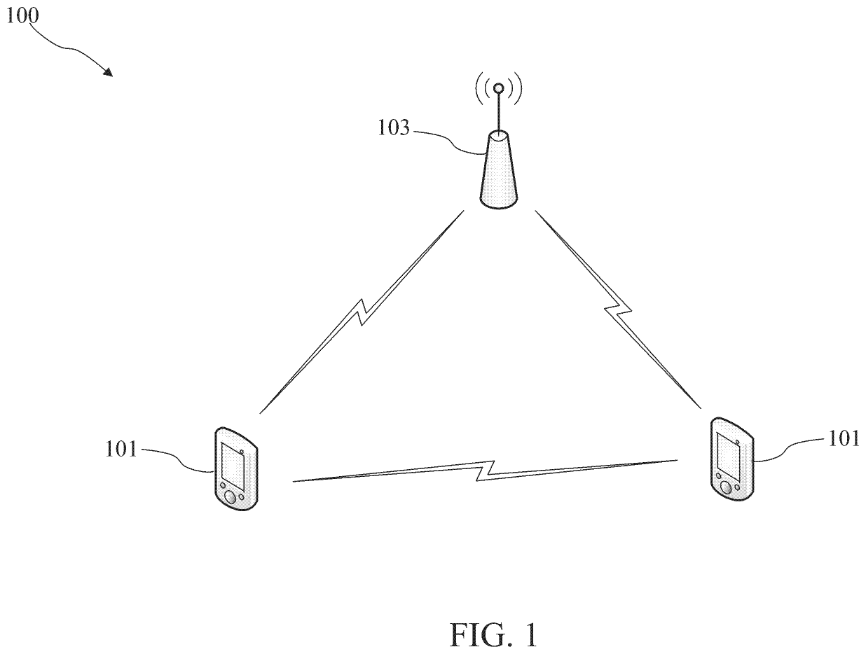

FIG. 1 illustrates a schematic diagram of a wireless communication system 100 in accordance with some embodiments of the present application. The wireless communication system 100 includes user equipment (UE) 101, a UE 102 and a base station (BS) 103. Although a specific number of UEs 101, 102 and BS 103 are depicted in FIG. 1, it is contemplated that any number of UE, BS and core network (CN) may be included in the wireless communication system 100.

The BS 103 may be distributed over a geographic region. In certain embodiments of the present application, the BS 103 may also be referred to as an access point, an access terminal, a base, a base unit, a macro cell, a Node-B, an evolved Node B (eNB), a gNB, a Home Node-B, a relay node, or a device, or described using other terminology used in the art. The BS 103 is generally part of a radio access network that may include one or more controllers communicably coupled to one or more corresponding BS(s).

The UEs 101 and 102 may include, for example, but is not limited to, computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), Internet of Thing (IoT) devices, or the like.

According to some embodiments of the present application, the UEs 101 and 102 may include, for example, but is not limited to, a portable wireless communication device, a smart phone, a cellular telephone, a flip phone, a device having a subscriber identity module, a personal computer, a selective call receiver, a wireless sensor, a monitoring device, or any other device that is capable of sending and receiving communication signals on a wireless network.

In some embodiments of the present application, the UEs 101 and 102 may include, for example, but is not limited to, wearable devices, such as smart watches, fitness bands, optical head-mounted displays, or the like. Moreover, the UEs 101 and 102 may be referred to as a subscriber unit, a mobile, a mobile station, a user, a terminal, a mobile terminal, a wireless terminal, a fixed terminal, a subscriber station, a user terminal, or a device, or described using other terminology used in the art. The UEs 101 and 102 may communicate with each other via sidelink transmission. The sidelink transmission may include a control information transmission on physical sidelink control channel (PSCCH), a data transmission on physical sidelink shared channel (PSSCH) or feedback transmission on physical sidelink feedback channel (PSFCH). The UE 101 and 102 may respectively communicate with the BS 103 via uplink communication signals.

The wireless communication system 100 is compatible with any type of network that is capable of sending and receiving wireless communication signals. For example, the wireless communication system 100 is compatible with a wireless communication network, a cellular telephone network, a time division multiple access

(TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

According to existing agreements, the UEs 101 and 102 may perform sidelink transmission on unlicensed band, and the UE 101 (e.g., a transmitting (TX) UE) may perform listen-before-talk (LBT) procedure before the sidelink transmission. The LBT procedure may include LBT Cat4 or LBT Cat2. LBT Cat2 means that a LBT procedure is performed without random back-off, and the duration of time that the channel is sensed to be idle before the transmitter transmits is deterministic. LBT Cat4 means that a LBT procedure is performed with random back-off with a variable contention window size.

Regarding sidelink transmission mode 2 (i.e., the mode that the UEs may autonomously select resources for sidelink transmission), if a TX UE determines the LBT type (e.g., LBT Cat4 or LBT Cat2) by itself, the TX UE may detect a cyclic prefix (CP) extension transmission from the other TX UE in a sensing interval and drop it sidelink transmission in subsequent time slot, which may decrease the resource utilization efficiency.

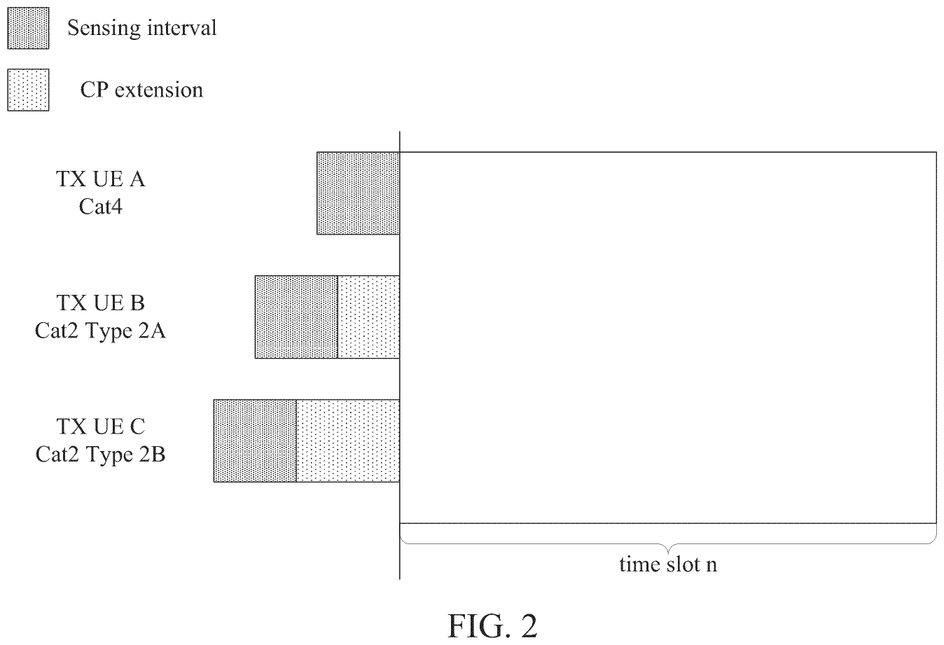

For example, referring to FIG. 2, when a TX UE A performs LBT Cat4, the TX UE A may detect, within a sensing interval, a CP extension transmission from a TX UE B which performs LBT Cat2 (type 2A). The TX UE B performs LBT type 2A may detect, within a sensing interval, a CP extension transmission from a TX UE C which performs LBT Cat2 (type 2B) with a longer CP extension. In this way, the UEs, which detect CP extension transmissions from other UEs, may drop their transmissions even their transmissions could utilize different frequency resource at the same time slot n. This may decrease the resource utilization efficiency.

Accordingly, in the present disclosure, to increase the resource utilization efficiency, a common CP extension per resource pool may be introduced. More details on embodiments of the present disclosure will be further described hereinafter.

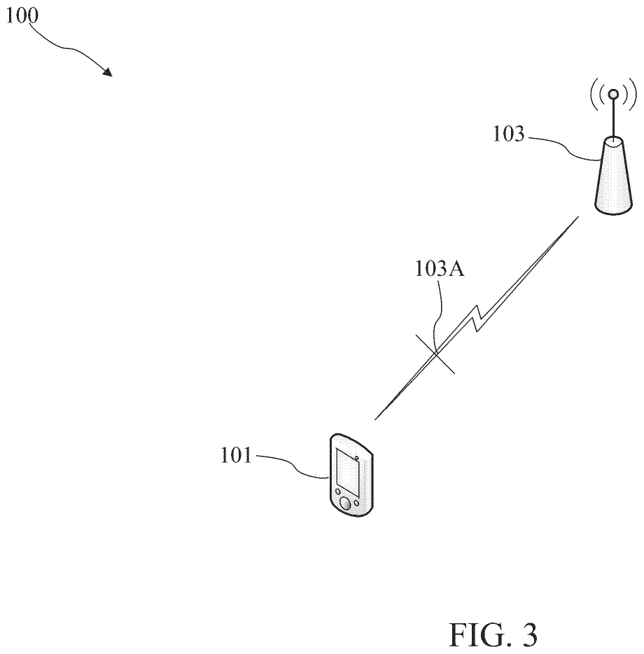

Referring to FIG. 3, in particular, the BS 103 may transmit a resource pool configuration information 103A to the UE 101 (i.e., the TX UE). The UE 101 may receive the resource pool configuration information 103A from the BS 103. The resource pool configuration information 103A may indicate a common CP extension per resource pool. More specifically, the resource pool configuration information 103A may indicate a CP extension having a length before a sidelink transmission in a resource pool. Then, the UE 101 may perform an LBT procedure for a CP extension transmission with the length and the sidelink transmission in the resource pool on an unlicensed band. Accordingly, the UE(s) using the resources in the same resource pool do not affect each other because they are indicated with the same length of CP extension.

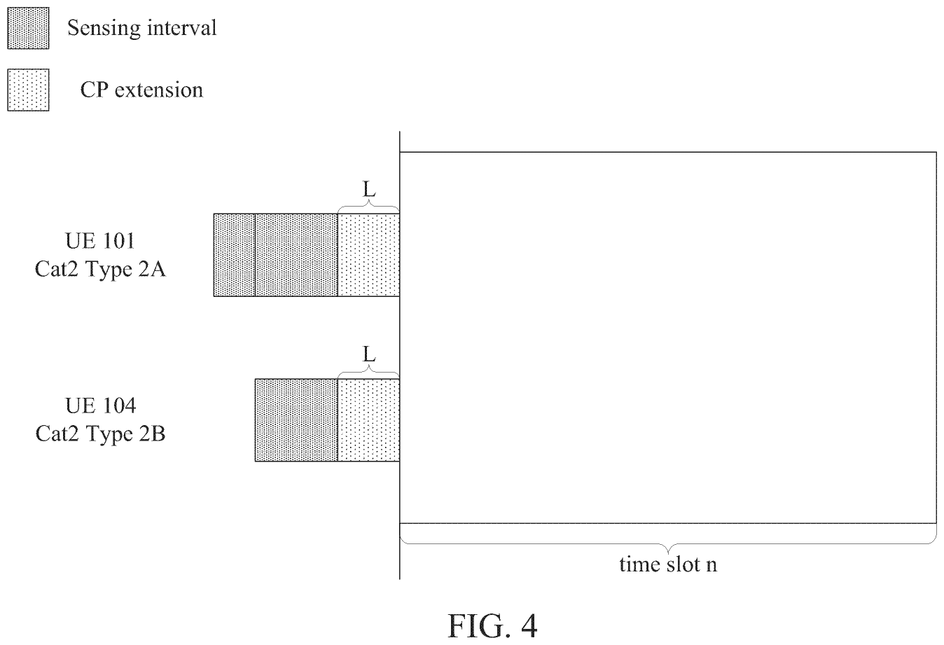

For example, referring to FIG. 4, the UE 101 performs LBT Cat2 (type 2A), a UE 104 performs LBT Cat 2 (type 2B) and they use the resources in the same resource pool indicated with same CP extension having the length ‘L’. When the UEs 101 and 104 can utilize different frequency resources for their sidelink transmissions at the same time slot n, the UEs 101 and 104 do not drop their sidelink transmissions because they do not affect each other due to the same length ‘L’ of CP extension.

More specifically, as shown in FIG. 4, since the CP extensions of the UEs 101 and 104 have the same length ‘L’, the UE 101 does not detect the CP extension transmission from the UE 104 in a sensing interval of the UE 101. Similarly, the UE 104 does NOT detect the CP extension transmission from the UE 101 in a sensing interval of the UE 104. Accordingly, neither the UE 101 nor 104 drops its subsequent sidelink transmission at the time slot n.

In some embodiments, the resource pool configuration information 103A may include an index that indicates the CP extension for the resource pool. For example, a table 1 of index, number of symbols and delta value below can be (pre) configured in the UE 101. Accordingly, when the UE 101 receives the resource pool configuration information 103A including an index ‘1’ for a number of symbols ‘C1’ for CP extension transmission and a corresponding delta value ‘delta 1’, the UE 101 determines the CP extension based on the length of number of symbols ‘C1’ minus ‘delta 1’.

TABLE 1

| index | Number of symbols | delta |
|---|---|---|
| 0 | — | — |
| 1 | C1 | delta 1 |
| 2 | C2 | delta 2 |
| 3 | C3 | delta 3 |

For another example, a table 2 of index and CP extension can be (pre) configured in the UE 101. Accordingly, when the UE 101 receives the resource pool configuration information 103A including an index ‘1’ for CP extension, the UE 101 determines the CP extension as 25·10⁻⁶.

TABLE 2

| index | CP extension |
|---|---|
| 0 | 16 · 10⁻⁶ |
| 1 | 25 · 10⁻⁶ |
| 2 | 34 · 10⁻⁶ |
| 3 | 43 · 10⁻⁶ |
| 4 | 52 · 10⁻⁶ |
| 5 | 61 · 10⁻⁶ |
| 6 | ${\sum }_{k = 1}^{{2}^{μ}} {T}_{s y m b , ( l - k ) mod 7 \cdot {2}^{μ}}^{μ}$ |

In some embodiments, the resource pool configuration information 103A may include a mapping relation between the index and a priority of sidelink transmission. For example, an item (i.e., the mapping relation) of a table 3 of indexes of CP extensions and priority levels of sidelink transmissions can be included in the resource pool configuration information 103A. Accordingly, after receiving the resource pool configuration information 103A, the UE 101 obtains the mapping relation between the index of CP extension (e.g., ‘3’) and the priority level (e.g., ‘1’) of sidelink transmission. It should be noted that the prior level with lower number has higher priority and is configured with the CP extension having longer length for occupying channel access more efficiently.

TABLE 3

| Priority | Index of CP extension |
|---|---|
| 7 | 0 |
| 6 | 0 |
| 5 | 1 |
| 4 | 1 |
| 3 | 2 |
| 2 | 2 |
| 1 | 3 |
| 0 | 3 |

In some embodiments, the resource pool configuration information 103A may indicate at least one sidelink channel access type for the resource pool. In other words, the resource pool configuration information 103A may indicate at least one sidelink channel access type for the CP extension transmission with the length and the sidelink transmission in the resource pool. For example, an item of a table 4 of indexes of CP extensions and channel access types of sidelink transmissions can be indicated by the resource pool configuration information 103A. Accordingly, when the UE 101 receives the resource pool configuration information 103A, the UE 101 determines the channel access types (e.g., ‘Typel-SLChannelAccess and Type2A-SLChannelAccess’) and the index of CP extension (e.g., ‘2’). It should be noted that the combinations of the channel access type and the index of the CP extension may be enumerated as below; it, however, is not intended to limit the combinations.

TABLE 4

| | Index of CP |
|---|---|
| Channel Access Type | extension |
| Type1-SLChannelAccess and Type2A-SLChannelAccess | 0 |
| Type1-SLChannelAccess and Type2A-SLChannelAccess | 1 |
| Type1-SLChannelAccess and Type2A-SLChannelAccess | 2 |
| Type1-SLChannelAccess and Type2A-SLChannelAccess | 3 |
| Type1-SLChannelAccess and Type2B-SLChannelAccess | 0 |
| Type1-SLChannelAccess and Type2B-SLChannel Access | 1 |
| Type1-SLChannelAccess and Type2B-SLChannel Access | 2 |
| Type1-SLChannelAccess and Type2B-SLChannel Access | 3 |
| Type1-SLChannelAccess and Type2C-SLChannelAccess | 0 |
| Type1-SLChannelAccess and Type2C-SLChannelAccess | 1 |
| Type1-SLChannelAccess and Type2C-SLChannelAccess | 2 |
| Type1-SLChannelAccess and Type2C-SLChannelAccess | 3 |
| Type1-SLChannelAccess | 0 |
| Type1-SLChannelAccess | 1 |
| Type1-SLChannelAccess | 2 |
| Type1-SLChannelAccess | 3 |
| Type2A-SLChannelAccess | 0 |
| Type2A-SLChannel Access | 1 |
| Type2A-SLChannelAccess | 2 |
| Type2A-SLChannelAccess | 3 |
| Type2B-SLChannelAccess | 0 |
| Type2B-SLChannelAccess | 1 |
| Type2B-SLChannelAccess | 2 |
| Type2B-SLChannelAccess | 3 |
| Type2C-SLChannelAccess | 0 |
| Type2C-SLChannelAccess | 1 |
| Type2C-SLChannelAccess | 2 |
| Type2C-SLChannelAccess | 3 |

Therefore, after receiving the resource pool configuration information 103A, the UE 101 may perform the LBT procedure based on the at least one sidelink channel access type for the CP extension transmission with the corresponding length and the sidelink transmission in the resource pool on the unlicensed band.

In some embodiments, the resource pool configuration information 103A may be included in a radio resource control (RRC) configuration or a downlink control information (DCI) from the BS 103 to the UE 101.

In addition, regarding sidelink communication mode 2, when a UE performs autonomous resource selection and the number of candidate resources remaining in a set is smaller than a network configured value, a reference signal receiving power (RSRP) threshold should be increased for raising the number of candidate resources to the network configured value. In this way, the UE may select a resource after increasing the RSRP threshold while the selected resource is used by another UE. Accordingly, LBT failure may be caused and the resource re-selection may be trigger, which may decrease the resource utilization efficiency.

Accordingly, in the present disclosure, to increase the resource utilization efficiency, a candidate resource set having greater number of candidate resources may be introduced. More details on embodiments of the present disclosure will be further described hereinafter.

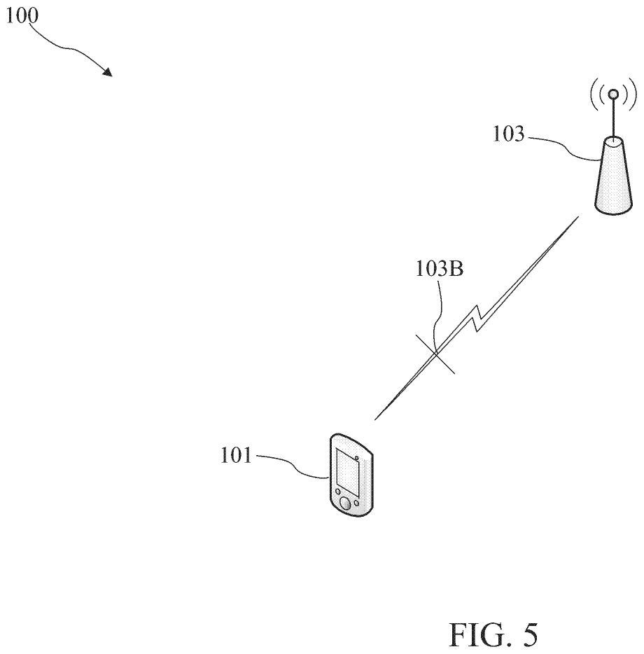

Referring to FIG. 5, the BS 103 may transmit a configuration 103B to the UE 101. The configuration 103B may include a number ‘N1’ of candidate resources while the number ‘N1’ is a default number (e.g., X·Mₜₒₜₐₗ defined in 3GPP specification) of candidate resource. Afterwards, the UE 101 may determine a candidate resource set having a number ‘N2’ of candidate resources while the number ‘N2’ is an advanced number of candidate resource. The number ‘N2’ of candidate resources is greater than the ‘N1’ configured by the BS 103. The UE 101 may report the candidate resource set from a physical (PHY) layer of the UE 101 to a higher layer of the UE 101. Then, the higher layer of the UE 101 may determine at least one resource from the candidate resource set for a sidelink transmission on the unlicensed band. Because the candidate resource set with the number ‘N2’ of candidate resources is larger than default candidate resource set with the number ‘N1’ of candidate resources, the efficiency of the resource (re) selection may be improved by reducing the possibility of selecting the wrong resource (e.g., the occupied resource, the resource where collision may happen). In some embodiments, the number ‘N2’ is determined per resource pool.

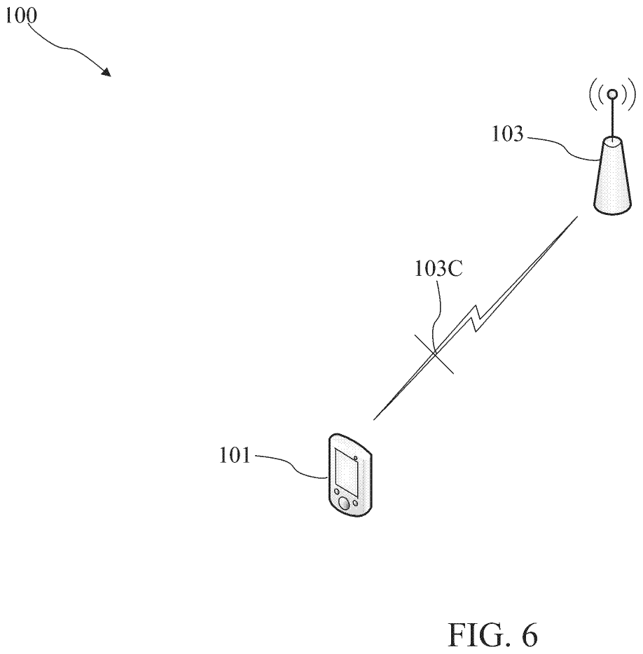

In some embodiments, the number ‘N2’ may be indicated by the BS 103. Referring to FIG. 6, in particular, the BS 103 may transmit a resource pool configuration information 103C to the UE 101. The UE 101 may receive the resource pool configuration information 103C from the BS 103. The resource pool configuration information 103C may include the number ‘N2’ of candidate resources.

In some embodiments, the number ‘N2’ may be determined by the UE 101 itself. In some cases, the UE 101 may directly determine a number greater the number ‘N1’ as the number ‘N2’. In some cases, the UE 101 may calculate a number of LBT failure, and then may determine the number ‘N2’ of candidate resources according to the number of LBT failure. The greater number of LBT failure is calculated, the greater number of ‘N2’ is determined. The number of LBT failure may be calculated by the PHY layer of the UE 101 or by the higher layer of the UE 101.

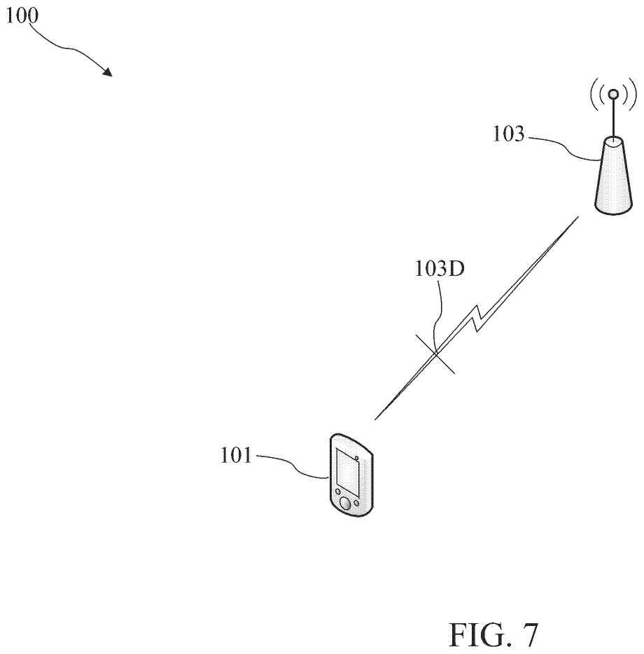

In some embodiments, the number ‘N1’ may be X·Mₜₒₜₐₗ and a factor X′ used for determining X′·Mₜₒₜₐₗ as the number ‘N2’ may be indicated by the BS 103. Referring to FIG. 7, in particular, the BS 103 may transmit a resource pool configuration information 103D to the UE 101. The UE 101 may receive the resource pool configuration information 103D from the BS 103. The resource pool configuration information 103D may include the factor X′. The UE 101 may then determine X′·Mₜₒₜₐₗ as the number ‘N2’.

In some embodiments, the number ‘N1’ may be X·Mₜₒₜₐₗ and a factor X′ used for determining X′·Mₜₒₜₐₗ as the number ‘N2’ may be determined by the UE 101 itself. In some cases, the UE 101 may directly determine a number greater X as the factor X′. In some cases, the UE 101 may calculate a number of LBT failure, and then may determine the factor X′ according to the number of LBT failure. The greater number of LBT failure is calculated, the greater value of the factor X′ is determined. The number of LBT failure may be calculated by the PHY layer of the UE 101 or by the higher layer of the UE 101.

In addition, in the present disclosure, to increase the resource utilization efficiency, the utilization of a plurality of resource sets may be introduced. More details on embodiments of the present disclosure will be further described hereinafter.

In particular, the UE 101 may report a candidate resource set from the PHY layer of the UE 101 to a higher layer of the UE 101. Then, the higher layer of the UE 101 may determine a plurality of sets of resource from the candidate resource set for a sidelink transmission on the unlicensed band. In some embodiments, multiple initial transmissions may be continuous in time domain. Therefore, the plurality of sets of resource determined from the candidate resource may be used for same transport block.

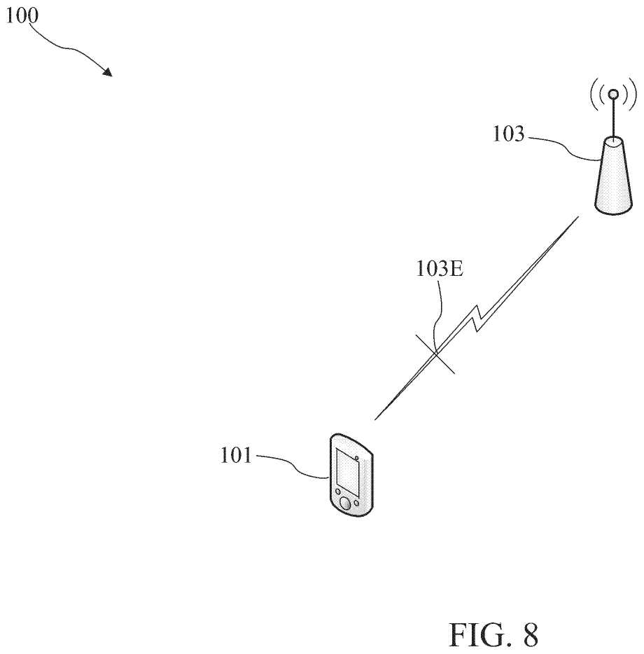

In some embodiments, a number of the sets of resource may be indicated by the BS 103. Referring to FIG. 8, in particular, the BS 103 may transmit a resource pool configuration information 103E to the UE 101. The UE 101 may receive the resource pool configuration information 103E from the BS 103. The resource pool configuration information 103E may include the number of the sets of resource.

In some embodiments, the number of the sets of resource may be determined by the UE 101 itself. In some cases, the UE 101 may directly determine a number greater one as the number of the sets of resource. In some cases, the UE 101 may calculate a number of LBT failure, and then may determine the number of the sets of resource according to the number of LBT failure. The greater number of LBT failure is calculated, the greater number of the sets of resource is determined. The number of LBT failure may be calculated by the PHY layer of the UE 101 or by the higher layer of the UE 101.

In addition, regarding sidelink communication mode 2, when a UE performs autonomous resource selection and the number of candidate resources remaining in a set is smaller than a network configured value, an RSRP threshold should be increased for raising the number of candidate resources to the network configured value. However, the increase of the RSRP threshold should be limited appropriately.

Accordingly, in the present disclosure, to limit the increase of the RSRP threshold used for resource selection under sidelink communication mode 2, the consideration of the energy detection threshold used for a UE to determine whether the channel is available (e.g., when the UE may perform LBT procedure, if a detected energy of signal is less than the energy detection threshold, the channel is available for sidelink transmission) may be introduced. More details on embodiments of the present disclosure will be further described hereinafter.

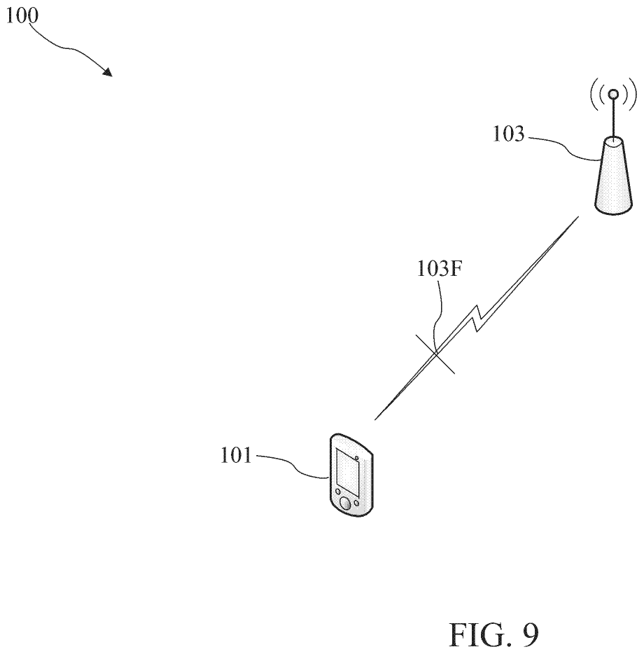

Referring to FIG. 9, the BS 103 may transmit a configuration 103F to the UE 101. The configuration 103F may include a number ‘N3’ of candidate resources while the number ‘N3’ is a default number (e.g., X·Mₜₒₜₐₗ defined in 3GPP specification) of candidate resource. The UE 101 may determine a candidate resource set having a number ‘N4’ of candidate resources. When the UE 101 determines that the number ‘N4’ is less than the number ‘N3’, the UE 101 may increase an RSRP threshold by a specific value (e.g., 3 dB). Then, the UE 101 may determine whether the increased RSRP threshold is greater than an energy detection threshold.

When the increased RSRP threshold is less than the energy detection threshold, the UE 101 may update the candidate resource set according to the increased RSRP threshold. In other words, the UE 101 may add resource(s), which satisfy the increased RSRP threshold, in the candidate set. When the increased RSRP threshold is equal to or greater than the energy detection threshold, the UE 101 may not update the candidate resource set and report the candidate resource set from the PHY layer of the UE 101 to the higher layer of the UE 101.

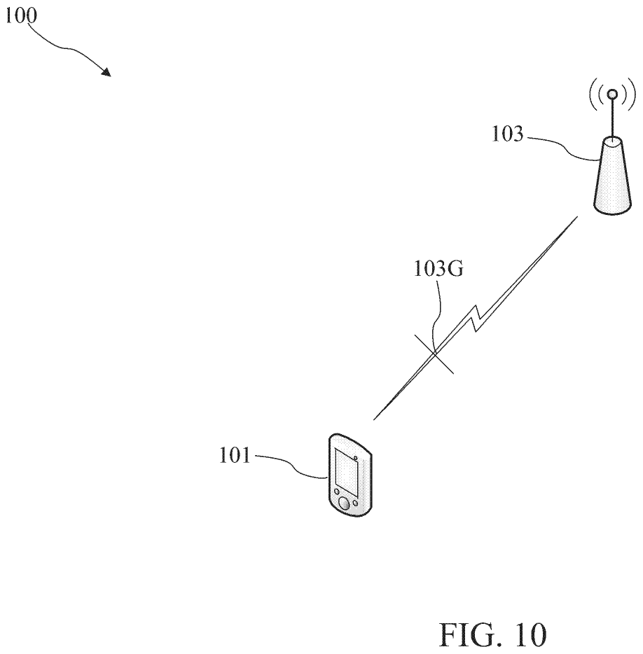

In some embodiments, the BS 103 may configure the UE 101 to report a number of LBT failure. Referring to FIG. 10, in particular, the BS 103 may transmit a configuration 103G to the UE 101. The configuration 103G may indicate a specific trigger mechanism to the UE 101. Accordingly, the UE 101 may report a number of LBT failure based on the specific trigger mechanism. In some cases, the specific trigger mechanism may be time-based (e.g., 100 ms or 1000 ms). In some cases, the specific trigger mechanism may be event-based (e.g., 10 times or 100 times of LBT failures).

In some embodiments, the UE 101 may report a number of LBT failure by itself. Similarly, the UE 101 may report a number of LBT failure periodically based on the specific trigger mechanism. In some cases, the specific trigger mechanism may be time-based (e.g., 100 ms or 1000 ms). In some cases, the specific trigger mechanism may be event-based (e.g., 10 times or 100 times of LBT failures).

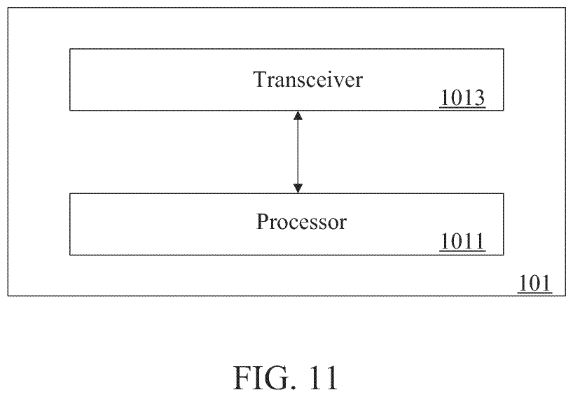

FIG. 11 illustrates example block diagrams of the UE 101 according to some embodiments of the present disclosure. As shown in FIG. 11, the UE 101 may include at least one non-transitory computer-readable medium (not illustrated in FIG. 11), a processor 1011 and a transceiver 1013. The processor 1011 may be electrically coupled to the non-transitory computer-readable medium (not illustrated in FIG. 11) and the transceiver 1013.

Although in this figure, elements such as processor 1011 and transceiver 1013 are described in the singular, the plural is contemplated unless limitation to the singular is explicitly stated. In certain embodiments of the present disclosure, the UE 101 may further include an input device, a memory, and/or other components.

In some embodiments of the present disclosure, the non-transitory computer-readable medium may have stored thereon computer-executable instructions to cause a processor to implement the procedure with respect to the UE 101 as described above. For example, the computer-executable instructions, when executed, cause the processor 1011 interacting with transceiver 1013, so as to perform the operations with respect to the UE 101 depicted in FIGS. 1, 3 to 10.

Those having ordinary skill in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including”.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE), comprising:
at least one memory; and
at least one processor coupled with the at least one memory and configured to cause the UE to:
receive a resource pool configuration information from a network node, wherein the resource pool configuration information indicates a length of cyclic prefix (CP) extension before a sidelink transmission in a resource pool; and
perform a listen-before-talk (LBT) procedure for a CP extension transmission with the length and the sidelink transmission in the resource pool on an unlicensed band.

2. The UE of claim 1, wherein the resource pool configuration information includes an index that indicates the CP extension for the resource pool.

3. The UE of claim 2, wherein the resource pool configuration information includes a mapping relation between the index and a priority of the sidelink transmission.

4. The UE of claim 1, wherein the resource pool configuration information further indicates a sidelink channel access type for the resource pool.

5. The UE of claim 4, wherein the at least one processor is configured to cause the UE to:
perform the LBT procedure based on the sidelink channel access type for the CP extension transmission with the length and the sidelink transmission in the resource pool on an unlicensed band.

6. The UE of claim 4, wherein the resource pool configuration information is included in a radio resource control (RRC) configuration or a downlink control information (DCI).

7. A user equipment (UE), comprising:
at least one memory; and
at least one processor coupled with the at least one memory and configured to cause the UE to:
determine a candidate resource set having a first number of candidate resources, wherein the first number of candidate resources is greater than a second number of candidate resources configured by a network node;
report the candidate resource set from a physical layer of the UE to a high layer of the UE; and
determine at least one resource from the candidate resource set by the high layer of the UE for a sidelink transmission on an unlicensed band.

8. The UE of claim 7, wherein the at least one processor is further configured to cause the UE to:
receive a resource pool configuration information from the network node, wherein the resource pool configuration information includes the first number of candidate resources.

9. The UE of claim 7, wherein the at least one processor is configured to cause the UE to:
determine the first number of candidate resource.

10. The UE of claim 9, wherein the at least one processor is further configured to cause the UE to:
calculate a number of listen-before-talk (LBT) failure;
wherein the first number of candidate resources is determined according to the number of LBT failure.

11. The UE of claim 7, wherein the second number of candidate resources is X*M configured by the network node, and the at least one processor is configured to cause the UE to:
receive a resource pool configuration information from the network node, wherein the resource pool configuration information includes a factor X′, and the first number of candidate resources is X′*M.

12. The UE of claim 7, wherein the second number of candidate resources is X*M configured by the network node, and the at least one processor is configured to cause the UE to:
determine a factor X′, and the first number of candidate resources is X′*M.

13. The UE of claim 12, wherein the at least one processor is configured to cause the UE to:
calculate a number of listen-before-talk (LBT) failure; and
wherein the factor X′ is determined according to the number of LBT failure.

14. A user equipment (UE), comprising:
at least one memory; and
at least one processor coupled with the at least one memory and configured to cause the UE to:
report a candidate resource set from a physical layer of the UE to a high layer of the UE; and
determine a plurality of sets of resource from the candidate resource set by the high layer of the UE for a sidelink transmission on an unlicensed band.

15. The UE of claim 14, wherein the at least one processor is configured to cause the UE to:
receive a resource pool configuration information from a network node, wherein the resource pool configuration information includes a number of sets of resource.

16. The UE of claim 14, wherein the at least one processor is configured to cause the UE to:
determine a number of sets of resource.

17. The UE of claim 16, wherein the at least one processor is configured to cause the UE to:
calculate a number of listen-before-talk (LBT) failure;
wherein the number of sets of resource is determined according to the number of LBT failure.

18. A user equipment (UE), comprising:
at least one memory; and
at least one processor coupled with the at least one memory and configured to cause the UE to:
determine a candidate resource set having a first number of candidate resources;
determine the first number of candidate resources is less than a second number of candidate resources configured by a network node;
increase a reference symbol received power (RSRP) threshold by a specific value; and
determine whether the increased RSRP threshold is greater than an energy detection threshold;
when the increased RSRP threshold is less than the energy detection threshold, update the candidate resource set according to the increased RSRP threshold;
when the increased RSRP threshold is equal to or greater than the energy detection threshold, report the candidate resource set to a higher layer of the UE.
